(19) United States
(12) Patent Application Publication
(10) Pub. No.: US 2011/0260979 A1
(43) Pub. Date: Oct. 27, 2011

(54) COMPUTER SYSTEM COMPLYING WITH DDC/CI PROTOCOL

(75) Inventor: YAN-LI ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/779,042

(22) Filed: May 12, 2010

(30) Foreign Application Priority Data
Apr. 22, 2010 (CN) 201010152399.7

(51) Int. Cl. G06F 3/02; G09G 5/00

(52) U.S. Cl. 345/168; 345/156

(57) ABSTRACT

A display including an input unit and a data display channel command interface (DDC/CI) based microprocessor is provided. A host having a DDC/CI based microcontroller is also provided. The DDC/CI microprocessor is programmed so that when a specific operation is performed on the input unit, the specific operation is converted into a host-switching signal by the microprocessor. The host-switching signal is received by the microcontroller via a DDC/CI based data line connecting the display and the host under DDC/CI protocol and converted into a host-switching request by the microcontroller for requesting the host to be switched on or off.

### BACKGROUND

1. Technical Field

The present disclosure relates to computer systems and, particularly, to a computer system complying with the data display channel command interface (DDC/CI) protocol.

2. Description of Related Art

Hosts of desktop computers are often received under desks. Therefore, many operations thereof are not convenient.

Therefore, it is desirable to provide a computer system, which can overcome the above-mentioned limitations.

### BRIEF DESCRIPTION OF THE DRAWINGS

Many aspects of the present computer system should be better understood with reference to the following drawings. The components in the drawings are not necessarily drawn to scale, the emphasis instead being placed upon clearly illustrating the principles of the present computer system. Moreover, in the drawings, like reference numerals designate corresponding parts throughout the several views.

FIG. 1 is a block diagram of a computer system, according to one embodiment.

FIG. 2 is an isometric, schematic view of the computer system of FIG. 1.

### DETAILED DESCRIPTION

Embodiments of the present computer system will now be described in detail with reference to the drawings.

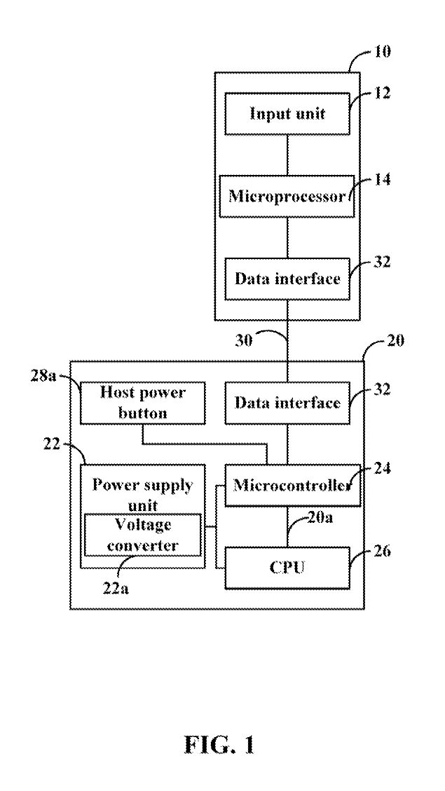

Referring to FIG. 1, a computer system 100, according to an embodiment, includes a display 10, a host 20, and a data display channel command interface (DDC/CI) based data line 30. The display 10 is connected to the host 20 through the data line 30. The display 10 includes an input unit 12 and a DDC/CI based microprocessor 14. The input unit 12 is for receiving user inputs. The microprocessor 14 is for converting the user inputs into a host-switching signal to power on/off the host 20. The host 20 includes a power supply unit 22, a DDC/CI based microcontroller 24, and a central processing unit (CPU) 26. The power supply unit 22 is configured for supplying power for the microcontroller 24 and the CPU 26 when the host 20 is connected to an external power supply but not turned on. As the microprocessor 14, microcontroller 24 and data lines 30 all comply with DDC/CI protocol, the microprocessor 14 can communicate with the microcontroller 24 via the data line 30 under the DDC/CI protocol. Thus, the host 20 can access display parameters and instructions, such as the host-switching signal, from the display 10, and also send commands to the display 10 for setting display parameters of the display 10 via the data line 30 under the DDC/CI protocol. The microcontroller 24 is configured for receiving the host-switching signal through data line 30 and sends a host-switching request to the CPU 26 once the host-switching signal is received to request the CPU 26 to power on/off the host. The CPU 26 is configured for sending a host-switching command to the power supply unit 22 to switch the host 20 on or off based upon the received host-switching request. As such, the host 20 can be switched on or off via the input unit 12 of the display 10, which is convenient.

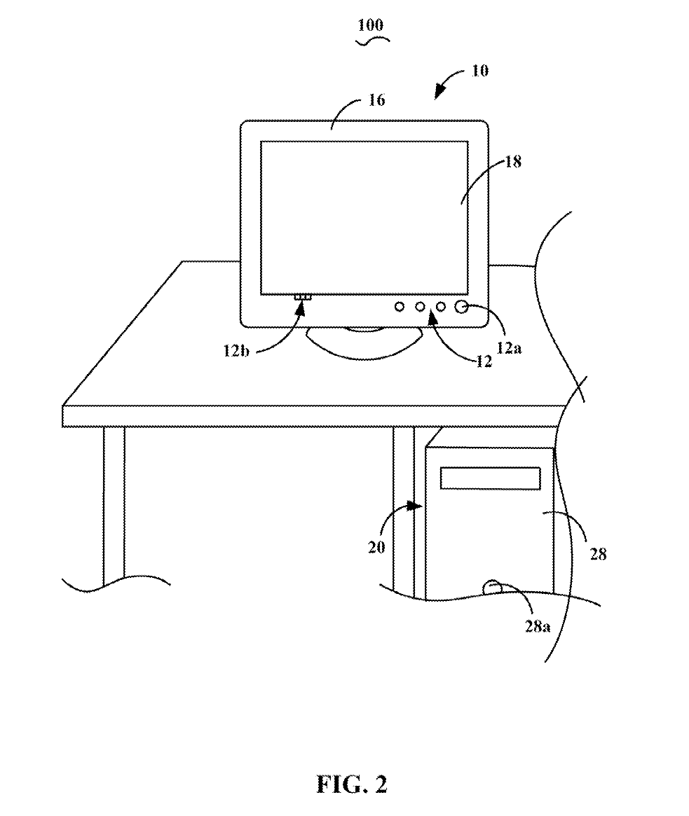

Referring to FIG. 2, the computer system 100 can be a desktop computer, for instance. However, in other embodiments, the computer system 100 also can be other types of computers.

The display 10 can be a liquid crystal display (LCD) and includes a frame 16, an LCD panel 18 framed by the frame 16, and a variety of required components (including the microprocessor 14) received in the frame 16. The input unit 12 includes a number of buttons mounted on the frame 16. Since the microprocessor 14 complies with DDC/CI protocol, the microprocessor 14 can be programmed so that when a specific user input is detected by the input unit 12, the user input can be converted into the host-switching signal. In this embodiment, the input unit 12 includes a display power button 12a. When the display power button 12a is pressed and quickly released, the microprocessor 14 converts the user input to a display-switching signal to power on/off the display 10. When the display power button 12a is pressed over a certain period of time (such as 3 seconds) and then released, the microprocessor 14 converts the user input into the display-switching signal and the host-switching signal. When the display power button 12a is pressed and released twice quickly, the microprocessor 14 converts the user input into the host-switching signal. The host-switching signal is sent to the host 20 via the data line 30 by the microprocessor 14.

It is noteworthy that the display 10 can be other types of displays. The input unit 12 can be a touch panel or an on screen display (OSD) system in other alternative embodiments.

The host 20 includes a chassis 28 and various required components (including the power supply unit 22, the microcontroller 24 and the CPU 26) housed in the chassis 28. The power supply unit 22 may include a voltage converter 22a. The voltage converter 22a can convert an output voltage of the external power supply, typically about 200V/AC (alternate current), into a rated voltage of the microcontroller 24 and the CPU 26 when the host 20 is connected to the external power supply. When the host 20 is not turned on, the microcontroller 24 and the CPU 26 are working in a standby mode, where the rated voltage of the microcontroller 24 and the CPU 26 is relatively low, about 3.3V/DC (direct current), thus the power consumption of the microcontroller 24 and the CPU 26 is relatively low. The microcontroller 24 can be a baseboard management controller (BMC) and can communicate with the CPU 26 via a system management bus (SMBus). The host-switching request is sent through the SMBus.

The display 10 and the host 20 each include a data interface 32. The data line 30 interconnects the two data interfaces 32 to connect the display 10 to the host 20. The data interfaces 32 can be but are not limited to a video graphics interface (VGA/D-sub), a digital visual interface (DVI), or a high-definition multimedia interface (HDMI).

In this embodiment, the display 10 also includes an indicator 12b. The indicator 12b is connected to the microprocessor 14 and is configured for indicating on/off states of the display 10 and the host 20. As such, users can recognize the on/off state of the host 20 and operate accordingly. The microcontroller 24 (e.g., the BMC) can detect the on/off state of the host 20 and send the on/off state of the host 20 to the microprocessor 14 through the data line 30. The microprocessor 14 also can detect the on/off state of the display 10 and control the indicator 12b based upon the received on/off state of the host 20 and the detected on/off state of the display 10. In this embodiment, the indicator 12b can be an array of light emitting diodes (LED) mounted on the frame 16. In detail, the indicator 12b includes three different color LEDs. When the display 10 and the host 20 are both off, the LEDs are all off. When only the display 10 is on, only a first color LED (e.g., a blue LED) of the indicator 12b is on. When only the host 20 is on, only a second color LED (e.g., a green LED) of the indicator 12b is on. When both the display 10 and the host 20 are on, only a third color LED (e.g., a red LED) of the indicator 12b is on.

In addition, the host 20 also includes a host power button 28a. The host power button 28a is connected to the microcontroller 24 and can send the host-switching signal to the microcontroller 24 when depressed for manually switching the host 20 on or off.

It will be understood that the above particular embodiments and methods are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A computer system comprising:
a display;
a host; and
a data display channel command interface (DDC/CI) based data line; the display being connected to the host through the data line and comprising an input unit and a DDC/CI based microprocessor; the input unit being configured for receiving user inputs; the microprocessor being configured for converting the user inputs into a host-switching signal; the host comprising a power supply unit, a DDC/CI based microcontroller, and a central processing unit (CPU); the power supply unit being configured for supplying power for the microcontroller and the CPU when the host is connected to an external power supply but not turned on, the microcontroller being configured for receiving the host-switching signal through data line and sending a host-switching request to the CPU once the host-switching signal is received; the CPU being configured for sending a host-switching command to the power source to switch on and off the host based upon the received host-switching request.

2. The computer system of claim 1, wherein the display comprises a frame and a display panel framed by the frame.

3. The computer system of claim 2, wherein the input unit comprises a keypad.

4. The computer system of claim 3, wherein the input unit comprises a display power button, the microprocessor being configured for converts a specific operation on the display power button by users into the host-switching signal.

5. The computer system of claim 4, wherein the specific operation is pressing and releasing the display power button for a specific period.

6. The computer system of claim 4, wherein the specific operation is pressing and releasing the display power button and quickly twice.

7. The computer system of claim 1, wherein the power supply unit comprises a voltage converter, the voltage converter being configured for converting voltage of the external power supply into a rated voltage of the microcontroller and the CPU.

8. The computer system of claim 1, wherein the microcontroller and the CPU are working in a standby mode in which a rated voltage and power of the microcontroller and the CPU are low.

9. The computer system of claim 1, wherein the microcontroller comprises a baseboard management controller.

10. The computer system of claim 1, wherein the microcontroller is connected the CPU via a system management bus.

11. The computer system of claim 1, wherein the display and the host each comprise a data interface, the data line interconnecting the data interfaces.

12. The computer system of claim 11, wherein the data interfaces are selected from the group consisting of a video graphics interface, a digital visual interface, and a high-definition multimedia interface.

13. The computer system of claim 1, wherein the display comprises an indicator, the indicator being connected to the microprocessor and configured for indicating on/off state of the display and the host.

14. The computer system of claim 13, wherein the indicator comprising a first color light emitting diode (LED), a second color LED, and a third color LED; when both the display and the host are off, the LEDs are off; when only the display is on, the first color LED is on; when only the host is on, the second color LED is on; when both the display and the host are on, the third color LED is on.

15. The computer system of claim 1, wherein the host comprises a host power button; the host power button being connected to the microcontroller and configured for sending the host-switching signal to the microcontroller when pressed.
